(19) United States
(12) Patent Application Publication
(10) Pub. No.: US 2009/0050733 A1
(43) Pub. Date: Feb. 26, 2009

(54) SIMPLE VTOL FLYING MACHINE

(76) Inventors: Manousos Pattakos, Nikea Piraeus (GR); Paraskevi Pattakou, Nikea Piraeus (GR); Emmanouel Pattakos, Nikea Piraeus (GR)

Correspondence Address: PATTAKOS Manousos, Lampraki 406, P.C. 18452 GR, Nikea Piraeus, 18452, GR

(21) Appl. No.: 11/679,874

(22) Filed: Feb. 28, 2007

(51) Int. Cl. B64C 27/22

(52) U.S. Cl. 244/17.11

(57) ABSTRACT

A compact and lightweight portable flyer.

Compared to the prior art, it is like an oversimplified synchropter without any casing or frame, without special control equipment, without servomechanisms. The body of the pilot is the sensors and the servomechanisms: just like a rider controls his bike with his body movements.

This patent relates to an easy to control Vertical Take-Off Landing (VTOL) flying machine which is simple, reliable, cheap and lightweight.

Compared to the prior art, it is like an oversimplified synchropter without any casing or frame, without special control equipment, without servomechanisms. The body of the pilot is the sensors and the servomechanisms: just like a rider controls his bike with his body motions.

The pilot, being inside the air stream generated by two counter-rotating rotors, can be hanged by the propulsion system the way a parachutist is hanged by his parachute. For the control of the flight, the pilot has as basic tools the position of his body relative to the propulsion system, the pose (i.e. the aerodynamic behaviour) of his body relative to the air stream, and the control of the propulsion system revs/load.

It is significant to liberate the pilot from any ‘reactions’ generated by the propulsion system, i.e. it is necessary a ‘reaction free’ or neutral propulsion system.

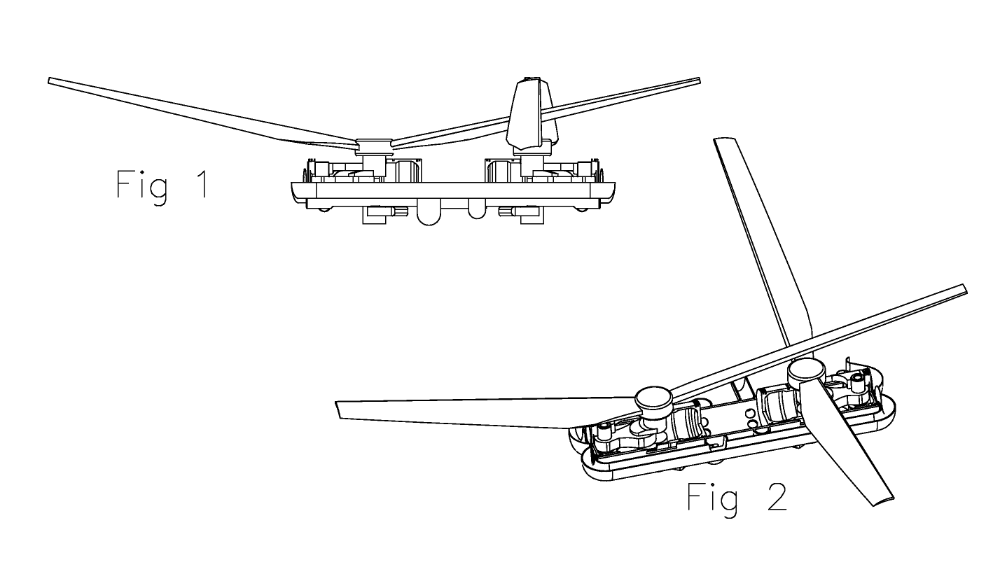

FIGS. 1 to 4 show a preferred embodiment.

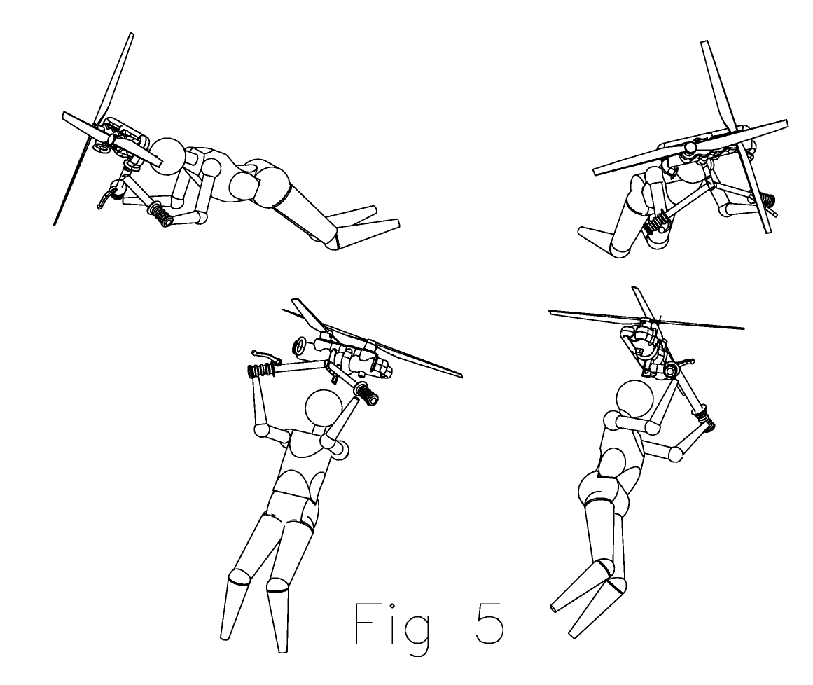

FIG. 5 shows the user/pilot hanged under the propulsion system.

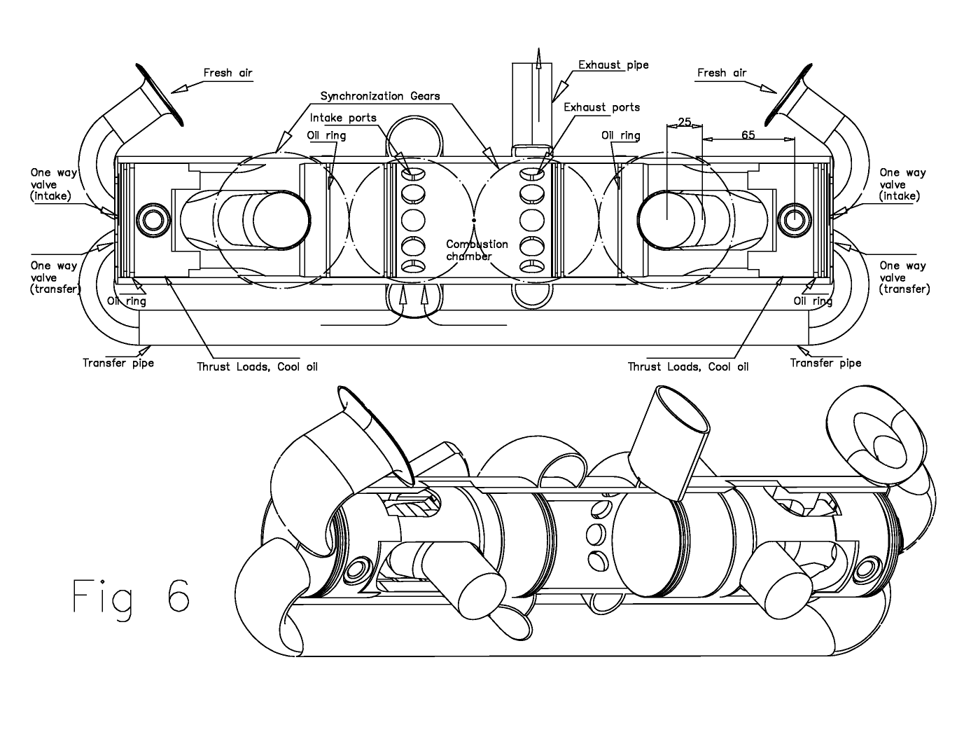

FIG. 6 shows a pulling rod opposed piston engine used as the prime mover in a preferred embodiment.

FIGS. 7 to 16 show some engine and rotors arrangements.

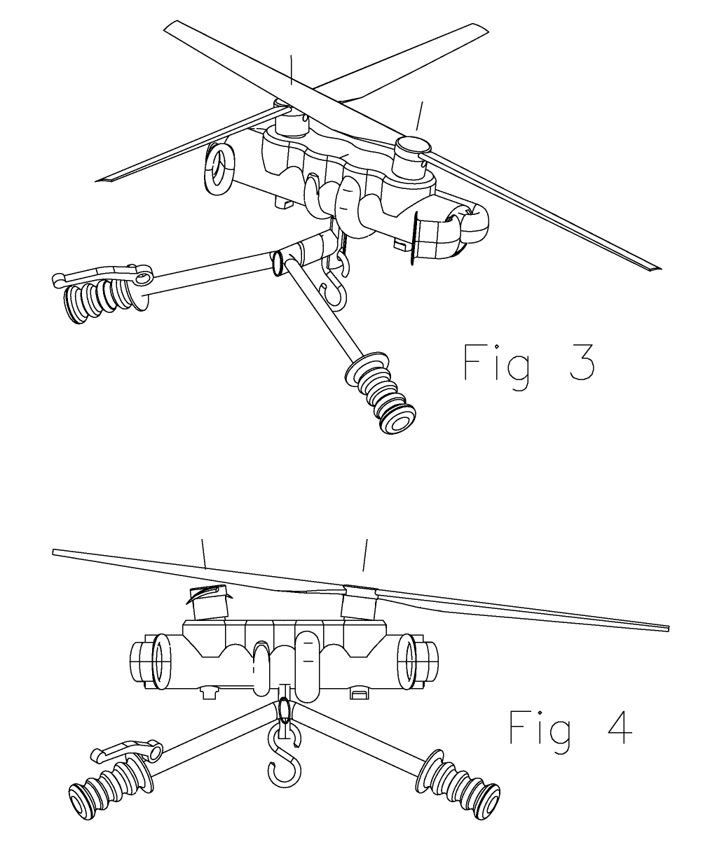

In a preferred embodiment, FIGS. 3 to 5 and 8, the propulsion system is an opposed piston engine, like the known Junkers engines or the opposed piston pulling rod engine of PCT/EP2007/050809, having two counter-rotating crankshafts sharing the same instant cylinder pressure, with their two crankshafts symmetrically rotating and sharing the torque equally. The absence of any reaction torque, the vibration free operation, the improved thermal efficiency and the light weight make the opposed piston engine ideal for such use. Two counter rotating intermeshing rotors are driven by the two counter-rotating crankshafts.

In order to involve long blade rotors, for instance for fuel economy, and at the same time to keep short the distance of the two rotor hubs, the rotor axes can be inclined to each other to allow the rotors being intermeshing (like, for instance, in the synchropter Kaman K225). Having two parallel counter-rotating crankshafts in a relatively short distance from each other, as those of the engine of FIG. 6, a constant velocity connection, called also Cardan connection, between the end of each crankshaft and its mate rotor is a simple, light, efficient and reliable way: the crankshafts stay parallel to each other while the axes of rotation of the rotors are inclined to each other at an angle providing the necessary clearance and safety. Each rotor is rotatably mounted on an inclined, relative to the crankshaft, basis of the engine casing, while a Cardan connection between the rotor hub and the end of the crankshaft transfers the torque from the crankshaft to the rotor keeping the revs unchanged. The gradual sweep of the blades of a rotor by the blades of the other rotor improves the aerodynamics and decreases the noise. If a change of the revs from the crankshafts to the rotors is desirable, the rotors can be attached not directly to the crankshafts but indirectly, for instance by the intermediate synchronizing gears shown by dashed dot circles in FIG. 6 or as shown in FIG. 9.

Alternatively, as shown in FIGS. 1, 2, 7, 9 and 12, rotors with parallel in short distance axes of rotation can be used, having blades slightly inclined relative to the rotation axis of the rotor they belong (i.e. each blade sweeps not a plane but a wide cone around the rotation axis of the rotor). This way there is no need for Cardan connections: the crankshafts can drive directly the intermeshing rotors without collision. This kind of rotor is still unconventional.

Both previous rotor arrangements, inclined conventional rotors and unconventional rotors comprising inclined blades, are true symmetrical and ‘neutral’, generating no reaction torque of any kind.

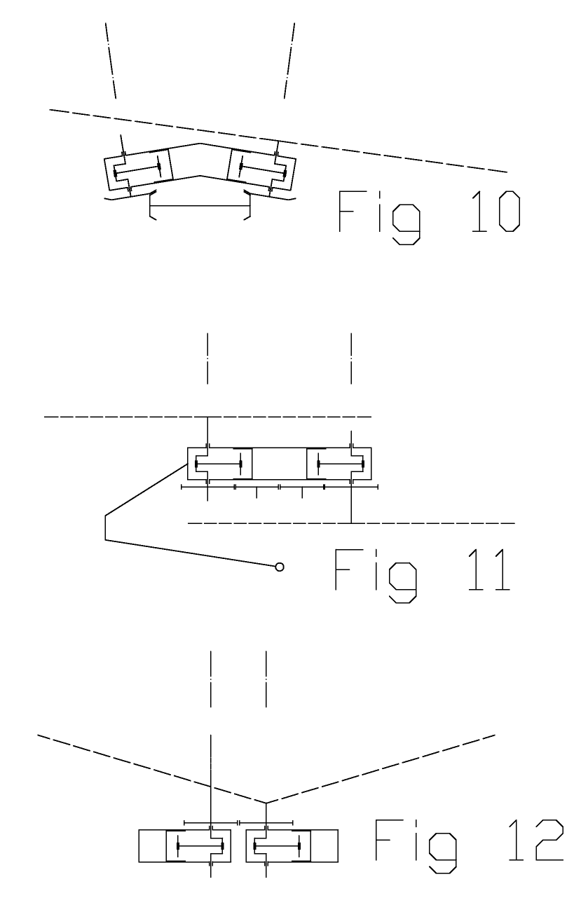

Alternatively two large diameter rotors having short distance between their axes, can be used, with one rotor being over the engine and the other rotor below the engine, either coaxial or at an offset as shown in FIG. 11. This rotor arrangement is not true symmetrical because the bottom rotor ‘sees’ different air flow than the top rotor.

In another preferred embodiment, the propulsion system can be the assembly of two similar conventional engines, interconnected in a way that their crankshafts rotate in opposite direction in synchronization, having simultaneous power pulses, as in FIG. 12. For the rest, the flying machine can be similar to that of the first preferred embodiment.

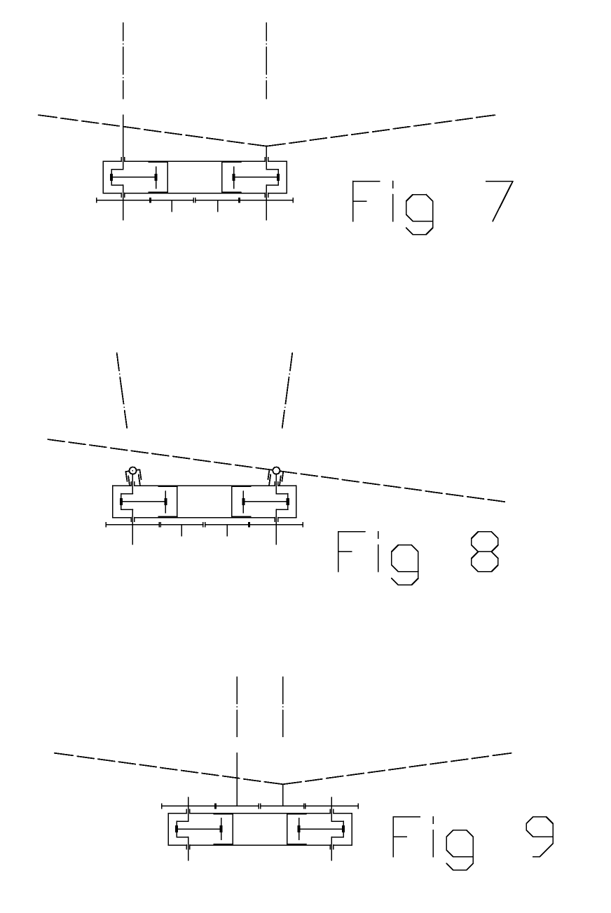

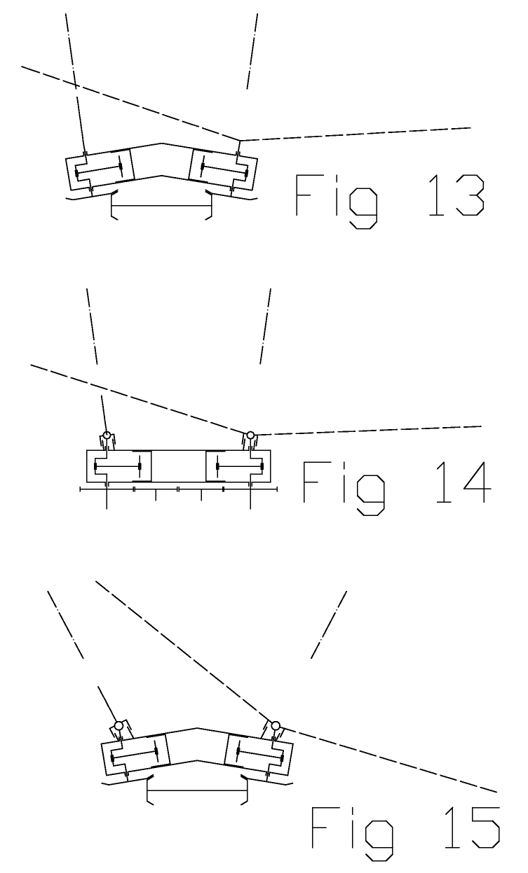

In another preferred embodiment shown in FIG. 10, the opposed piston engine can be slightly modified to a wide Vee almost opposed piston engine having two slightly inclined counter-rotating crankshafts sharing the same combustion chamber. This way long blade intermeshing conventional rotors directly secured to the inclined crankshafts can be used. Bevel gears can be used for the synchronization of the two crankshafts. In FIG. 13, the wide Vee almost opposed piston engine of FIG. 10 is combined with the inclined blade rotors of FIG. 7. In FIG. 14 the inclined blade rotors of FIG. 7 are combined with the Cardan connections of FIG. 8.

In FIG. 15 the inclined blade rotors of FIG. 7 are combined with the Cardan connections of FIG. 8 and with the wide Vee almost opposed piston engine of FIG. 10.

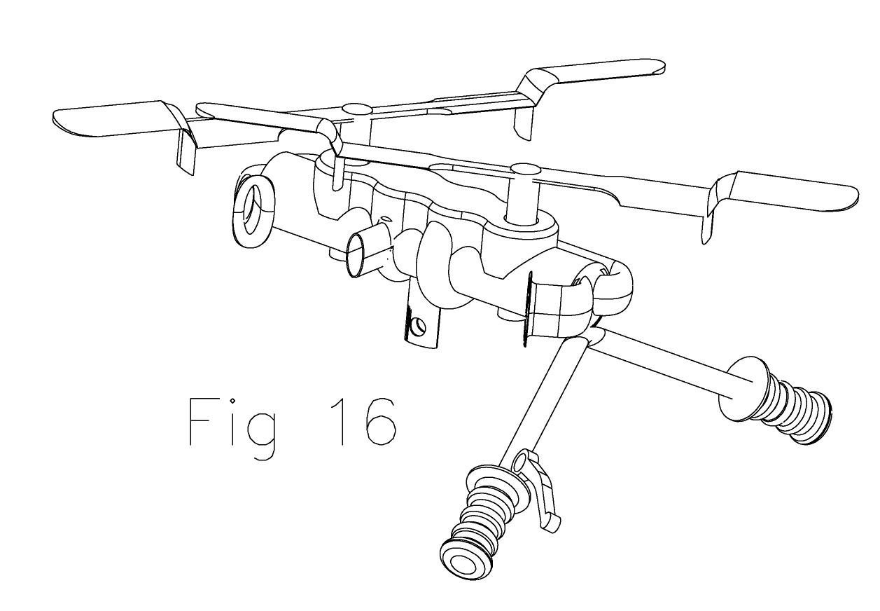

In FIG. 16 instead of the inclined blades of FIGS. 1 and 2, the blades of the rotors are step blades. The rotors are intermeshing and rotate without collision. The geometrical characteristic is that as the inclined blades or the step blades rotate, they sweep a substantially not plane surface.

For hovering, the user/pilot keeps his body directly downwards the rotors and changes slightly the revs of the prime mover by a gas cable. Lower engine revs and the flying machine moves downwards, higher engine revs and the flying machine moves upwards. Changing properly his body pose, for instance by moving a little forward his left foot and a little backwards his right foot, the flying system can start rotating around the vertical axis, just like a free fall diver controls his flight before opening his parachute.

After the vertical take-off, the user/pilot can slightly pull the handle bars, or grips, increasing simultaneously the revs of the engine, to change the flight from simple hovering to horizontal movement. To change direction, he can use the handle bars the way a child uses the handle bars of its bicycle. As the horizontal speed of the flying machine increases, the body of the user/pilot takes a more horizontal pose reducing air resistance, by the smaller frontal surface and the better streamlining, acting also as a plane wing. This wing effect can be multiplied by proper clothing/accessories.

The symmetry of the prime mover/rotors assembly, i.e. the elimination of any undesirable reaction, allows the user/pilot to deal only with the true control of his flight. If desirable, electronic sensors and servomechanisms can be used, especially for unmanned flights, as well as rotors with pitch control.

The weight of such a flying machine is minimized, comprising only the weight of the engine, of the rotors, of the user and of the fuel.

During take-off and landing, a lightweight tripod may be useful to hold the engine/rotors. After take-off the tripod can be folded and stored until the next landing.

The fuel tank can be suspended from the engine just like the user.

A parachute and an air bag are simple ‘safety’ means.

The elimination of any frame and of any transmission are invaluable advantages for a flying machine.

A horizontal opposed piston engine having zero reaction torque, two rotors above the opposed piston engine driven by the two counter-rotating crankshafts and a pilot hanged by the opposed piston engine, constitute a functional and easy to control flying machine which seems difficult to be simplified any further.

The applicability of such a flying machine is limitless, for instance for rescue teams for downtown emergency, sea emergency, narrow canyon emergency etc.

What is claimed is:

1. A flying machine comprising at least:
an opposed piston engine, said opposed piston engine having a first crankshaft and a second crankshaft, said first crankshaft and said second crankshaft being counter-rotating in synchronization;
a first rotor;
a second rotor;
a pilot;
characterized in that:
the first rotor is attached, by means of a constant velocity connection, at one end of the first crankshaft in order to rotate about an axis inclined to the axis of rotation of the first crankshaft,
the second rotor is attached, by means of a constant velocity connection, at one end of the second crankshaft in order to rotate about an axis inclined to the axis of rotation of the second crankshaft,
the first rotor and the second rotor being intermeshed,
the pilot is below the opposed piston engine, the control of the flight is made by changing the position and pose of the body of the pilot relative to the flying machine and by controlling the opposed piston engine revs.

2. As in claim 1 wherein in place of the pilot is a load and the control of the flying machine is made by sensors and servomechanisms.

3. As in claim 1 wherein the rotors are attached not to the crankshafts directly, but to secondary shafts driven by the crankshafts.

4. A flying machine comprising at least:
an opposed piston engine, said opposed piston engine having a first crankshaft and a second crankshaft, said first crankshaft and said second crankshaft being counter-rotating in synchronization having substantially parallel axes of rotation;
a first rotor, said first rotor being attached at one end of said first crankshaft;
a second rotor, said second rotor being attached at one end of said second crankshaft;
a pilot;
characterized in that:
the first rotor and the second rotor having blades sweeping substantially not plane surface around their rotor axis in order to rotate without collision,
the pilot is hanged below said opposed piston engine,
the control of the flight is made by changing the position and pose of the body of the pilot relative to said flying machine and by controlling the opposed piston engine revs.

5. A flying machine comprising at least:
a prime mover;
two rotors;
characterized in that;
the prime mover drives the two rotors to counter-rotate in synchronization,
the prime mover being of an arrangement that substantially reduces the reaction torque from the prime mover to the flying machine as the prime mover provides torque to the two rotors,
the pilot or load is supported on the prime mover,
the control of the flight is made by changing the position and pose of the body of the pilot, or of the load, relative to the flying machine and by controlling the prime mover revs.

6. As in 5 wherein the two rotors are intermeshing, having inclined rotation axes, the rotors being driven by means of constant velocity connections.

7. As in 5 wherein the two rotors are intermeshing, having blades sweeping substantially not plane surfaces around their rotation axis, in order to rotate without collision.

8. As in 5 wherein one of the two rotors is over the prime mover while the other rotor, of the two rotors, is below the prime mover.

9. As in 5 wherein the prime mover comprises two reciprocating engines and a mechanism to keep their crankshafts counter-rotating in synchronization and in proper phase.

10. As in claim 5 wherein the prime mover is a wide Vee almost opposed piston engine having two inclined counter-rotating crankshafts sharing the same combustion chamber to allow the use of intermeshing long blade conventional rotors directly driven by the inclined crankshafts.

11. As in claim 5 wherein the prime mover is a wide Vee almost opposed piston engine having two inclined counter-rotating crankshafts sharing the same combustion chamber, the two rotors are intermeshing having blades sweeping substantially not plane surfaces around their rotation axis.

12. As in claim 5 wherein neither the power shafts of the prime mover are necessarily parallel, nor the blades of the rotors are necessarily perpendicular to their rotation axis, nor the rotors are necessarily fixed on their shafts but can be connected by means of Cardan connection, nor the rotors are necessarily of constant pitch.
